(19) United States
(12) Patent Application Publication
(10) Pub. No.: US 2024/0146424 A1
(43) Pub. Date: May 2, 2024

(54) CROSS LINK INTERFERENCE REPORTING IN 5G COMMUNICATION SYSTEMS

(71) Applicant: Apple Inc., Cupertino, CA (US)

(72) Inventors: Seyed Ali Akbar FAKOORIAN, San Diego, CA (US); Wei ZENG, Saratoga, CA (US); Hong HE, San Jose, CA (US); Xiang CHEN, Campbell, CA (US); Ankit BHAMRI, Bad Nauheim (DE); Chunhai YAO, Beijing (CN); Oghenekome OTERI, San Diego, CA (US)

(73) Assignee: Apple Inc., Cupertino, CA (US)

(21) Appl. No.: 18/225,999

(22) Filed: Jul. 25, 2023

Related U.S. Application Data
(60) Provisional application No. 63/421,852, filed on Nov. 2, 2022.

(51) Int. Cl. H04B 17/336; H04B 17/318; H04W 72/1273; H04W 72/232

(52) U.S. Cl. CPC H04B 17/336; H04B 17/328; H04W 72/1273; H04W 72/232; H04L 1/1822

(57) ABSTRACT

Systems, methods, and apparatuses disclosed herein can generate and report a cross link interference (CLI) report. These systems, methods, and apparatuses can receive a CLI report configuration that outlines requirements for the CLI report, where the CLI report configuration is received on Layer 1 signaling, for example, Downlink Control Information (DCI) on a Physical Downlink Control Channel (PDCCH) or Layer 2 signaling, for example, downlink (DL) Media Access Control-Control Element (MAC-CE) on Physical Downlink Shared Channel (PDSCH). The CLI report configuration can identify the one or more CLI measurement resources to be measured and reported; one or more CLI measurements to be performed on the one or more CLI measurement resources; one or more CLI measurement occasions to measure the one or more CLI measurement resources; and one or more resources, to be used to report the CLI report. These systems, methods, and apparatuses can generate the CLI report as outlined in the CLI report configuration. Thereafter, these methods, and apparatuses can report the CLI report on Layer 1 signaling, for example, Uplink Control Information (UCI) on a Physical Uplink Control Channel (PUCCH) or Layer 2 signaling, for example, uplink (UL) Media Access Control-Control Element (MAC-CE) on Physical Uplink Shared Channel (PUSCH).

### CROSS-REFERENCE TO RELATED APPLICATIONS

The present application claims the benefit of United States Provisional Patent Application No. 63/421,852, filed Nov. 2, 2022, which is incorporated herein by reference in its entirety.

### BACKGROUND

A wireless network, for example, one compliant with 3rd Generation Partnership Project (3GPP) standards, can include many electronic devices, such as a first user equipment (UE) and a first base station (BS). The first BS can transmit on a downlink (DL) to the first UE and the first UE can transmit on an uplink (UL) to the first BS. In some situations, the wireless network can include a second UE that is transmitting on the UL to the first BS while the first UE is receiving on the DL which may cause cross link interference (CLI) between the first UE and the second UE. In other situations, the wireless network can include a second BS that is transmitting on the DL while the first BS is receiving on the UL which may cause CLI between the first BS and the second BS. Because of the large transmit power discrepancy between UL and DL, and/or propagation conditions, the CLI can be detrimental to performance of the wireless network.

### SUMMARY OF DISCLOSURE

Some embodiments of this disclosure describe a method for generating and reporting a cross link interference (CLI) report in a wireless network. The method includes receiving a CLI report configuration; configuring the electronic device to measure a CLI resource identified in the CLI report configuration; performing a CLI measurement of a CLI resource identified in the CLI report configuration over one or more of CLI measurement occasions identified in the CLI report configuration to provide one or more CLI measurements; generating a CLI report of the one or more CLI measurements; and reporting the CLI report to another electronic device within the wireless network.

In some embodiments, the receiving can include receiving the CLI report configuration on Layer 1 signaling. In these embodiments, the Layer 1 signaling can include Downlink Control Information (DCI) on a Physical Downlink Control Channel (PDCCH) as part of scheduling a Physical Downlink Shared Channel (PDSCH).

In some embodiments, the receiving can include receiving the CLI report configuration on Layer 2 signaling. In these embodiments, the Layer 2 signaling can include a Media Access Control-Control Element (MAC-CE) on a Physical Downlink Shared Channel (PDSCH).

In some embodiments, the performing can include measuring a CLI-reference signal received power (CLI-RSRP), a CLI-received signal strength indicator (CLI-RSSI), a CLI-reference signal received quality (CLI-RSRQ), or a CLI-signal-to-interference-plus-noise ratio (CLI-SINR) of the CLI resource.

In some embodiments, the reporting can include reporting the CLI report configuration on Layer 1 signaling. In these embodiments, the Layer 1 signaling can include resources of a Physical Uplink Control Channel (PUCCH) that are identified by the CLI report configuration that are similarly identified by Downlink Control Information (DCI) for use for a Hybrid Automatic Repeat Request (HARD) report.

In some embodiments, the reporting can include reporting the CLI report configuration on Layer 2 signaling. In these embodiments, the Layer 2 signaling comprises a Media Access Control-Control Element (MAC-CE) on resources of a Physical Uplink Shared Channel (PUSCH) identified in the CLI report configuration.

Some embodiments of this disclosure describe an electronic device having a transceiver and a processor that is coupled to the transceiver. The transceiver receives Downlink Control Information (DCI) having a CLI report configuration. The processor performs a CLI measurement of a CLI resource identified in the CLI report configuration over one or more CLI measurement occasions identified in the CLI report configuration to provide one or more CLI measurements, and generate a CLI report of the one or more CLI measurements. The transceiver can report the CLI report on a Physical Uplink Control Channel (PUCCH) identified in the CLI report configuration.

In some embodiments, the DCI can include a new bit-field that is not outlined in a 3rd Generation Partnership Project (3GPP) standard that includes the CLI report configuration.

In some embodiments, the processor can annex the CLI report onto one or more other measurement reports that are outlined by a 3rd Generation Partnership Project (3GPP) standard and the transceiver can report the one or more other measurement reports on the PUCCH.

In some embodiments, the one or more other measurement reports can include a Hybrid Automatic Repeat Request (HARQ) report.

In some embodiments, resources on the PUCCH identified in the CLI report configuration are resources on the PUCCH that are similarly identified by the DCI to report the HARQ report.

In some embodiments, the processor can measure a CLI-reference signal received power (CLI-RSRP), a CLI-received signal strength indicator (CLI-RSSI), a CLI-reference signal received quality (CLI-RSRQ), or a CLI-signal-to-interference-plus-noise ratio (CLI-SINR) of the CLI resource.

Some embodiments of this disclosure describe an electronic device that includes a memory and processor. The memory stores instructions. The processor executes the instructions stored in the memory, the instructions, when executed by the processor, configuring the processor to: recover a CLI report configuration from a downlink (DL) Media Access Control-Control Element (MAC-CE) on a Physical Downlink Shared Channel (PDSCH), perform a CLI measurement of a CLI resource identified in the CLI report configuration over one or more CLI measurement occasions identified in the CLI report configuration to provide one or more CLI measurements, and generate a CLI report of the one or more CLI measurements that is to be reported on a Physical Uplink Shared Channel (PUSCH) using an uplink (UL) MAC-CE to another electronic device within a wireless network.

In some embodiments, the electronic device can include a user equipment (UE) and the other electronic device can include a base station (BS).

In some embodiments, the instructions, when executed by the processor, further configure the processor to annex the CLI report onto one or more other measurement reports that are outlined by a 3rd Generation Partnership Project (3GPP) standard.

In some embodiments, the one or more other measurement reports can include a Hybrid Automatic Repeat Request (HARQ) report.

This Summary is provided merely for purposes of illustrating some embodiments to provide an understanding of the subject matter described herein. Accordingly, the above-described features are merely examples and should not be construed to narrow the scope or spirit of the subject matter in this disclosure. Other features, aspects, and advantages of this disclosure will become apparent from the following Detailed Description, Figures, and Claims.

### BRIEF DESCRIPTION OF THE FIGURES

The accompanying drawings, which are incorporated herein and form part of the specification, illustrate the disclosure and, together with the description, further serve to explain the principles of the disclosure and enable a person of skill in the relevant art(s) to make and use the disclosure.

FIG. 1A and FIG. 1B graphically illustrate exemplary wireless networks having cross link interference (CLI) in accordance with various embodiments of the present disclosure.

FIG. 2 graphically illustrates an exemplary timeline for generating and reporting an exemplary CLI report within the exemplary wireless networks in accordance with various embodiments of the present disclosure.

FIG. 3A through FIG. 3C graphically illustrate exemplary timelines for exemplary Layer 1 signaling within the generating and the reporting of the exemplary CLI report in accordance with various embodiments of the present disclosure.

FIG. 4 graphically illustrate an exemplary timeline for exemplary Layer 2 signaling within the generating and the reporting of the exemplary CLI report in accordance with various embodiments of the present disclosure.

FIG. 5 illustrates a flowchart of an exemplary operation for generating and reporting the exemplary CLI report within the exemplary wireless networks in accordance with various embodiments of the present disclosure.

FIG. 6 illustrates a block diagram of an electronic device for generating and reporting the exemplary CLI report within the exemplary wireless networks in accordance with various embodiments of the present disclosure.

FIG. 7 illustrates a block diagram of an exemplary computer system that can be implemented within the exemplary wireless networks according to some exemplary embodiments of the present disclosure.

The disclosure is described with reference to the accompanying drawings. In the drawings, generally, like reference numbers indicate identical or functionally similar elements. Additionally, generally, the left-most digit(s) of a reference number identifies the drawing in which the reference number first appears.

### DETAILED DESCRIPTION

Overview

Systems, methods, and apparatuses disclosed herein can generate and report a cross link interference (CLI) report. These systems, methods, and apparatuses can receive a CLI report configuration that outlines requirements for the CLI report, where the CLI report configuration is received on Layer 1 signaling, for example, Downlink Control Information (DCI) on a Physical Downlink Control Channel (PDCCH) or Layer 2 signaling, for example, downlink (DL) Media Access Control-Control Element (MAC-CE) on Physical Downlink Shared Channel (PDSCH). The CLI report configuration can identify the one or more CLI measurement resources to be measured and reported; one or more CLI measurements to be performed on the one or more CLI measurement resources; one or more CLI measurement occasions to measure the one or more CLI measurement resources; and one or more resources, to be used to report the CLI report. These systems, methods, and apparatuses can generate the CLI report as outlined in the CLI report configuration. Thereafter, these methods, and apparatuses can report the CLI report on Layer 1 signaling, for example, Uplink Control Information (UCI) on a Physical Uplink Control Channel (PUCCH) or Layer 2 signaling, for example, uplink (UL) Media Access Control-Control Element (MAC-CE) on Physical Uplink Shared Channel (PUSCH).

### Exemplary Wireless Networks Having Cross Link Interference (CLI)

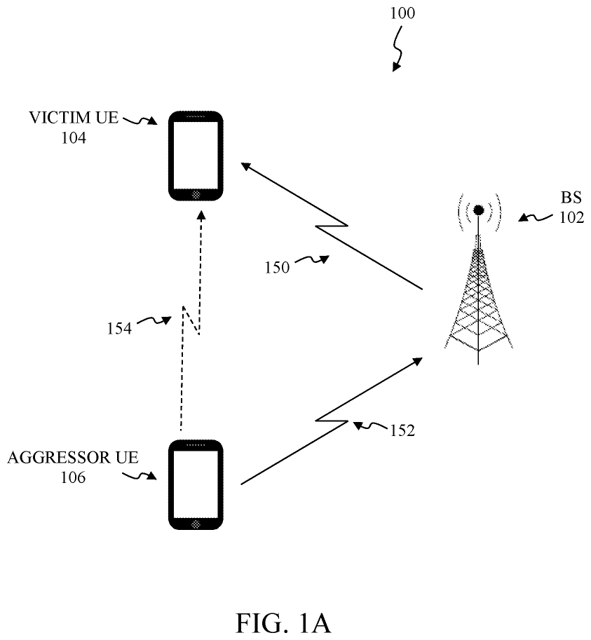

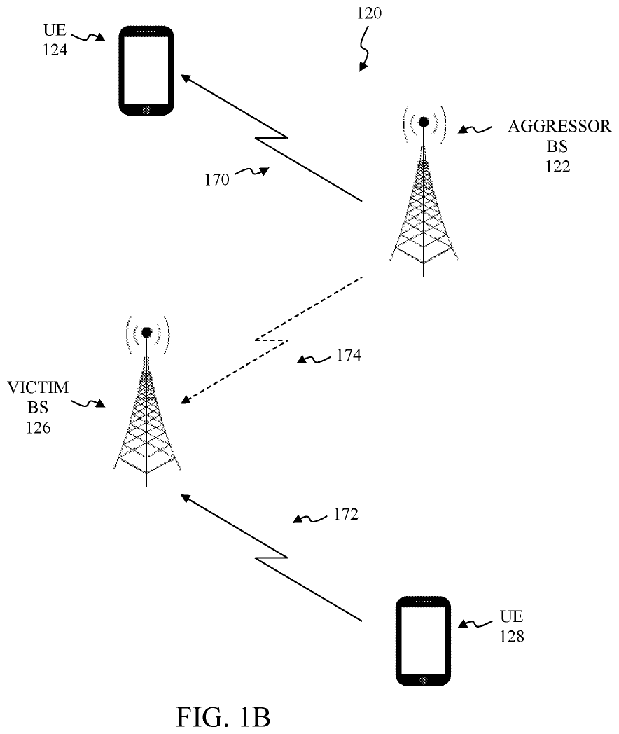

FIG. 1A and FIG. 1B graphically illustrate exemplary wireless networks having cross link interference (CLI) in accordance with various embodiments of the present disclosure. In the exemplary embodiment illustrated in FIG. 1A, a first wireless network 100 includes a base station (BS) 102, a victim user equipment (UE) 104, and an aggressor UE 106. As illustrated in FIG. 1A, the BS 102 can transmit on a downlink (DL) 150 to the victim UE 104. As used herein, the terms downlink, DL, or the like refer to a first direction from a BS, such as the BS 102 to provide an example, to a UE, such as the victim UE 104 to provide an example. The DL 150 can include one or more downlink communication channels, for example, a Physical Downlink Control Channel (PDCCH) and/or a Physical Downlink Shared Channel (PDSCH). The PDCCH represents a downlink channel that carries control information between the BS 102 and the victim UE 104. And the PDSCH represents a downlink channel that carries data information between the BS 102 and the victim UE 104. And as illustrated in FIG. 1A, the BS 102 receive on an uplink (UL) 152 from the aggressor UE 106. As used herein, the terms uplink, UL, or the like refers to a second direction from a UE, such as the aggressor UE 106 to provide an example, to a BS, such as the BS 102 to provide an example. The UL 152 can include one or more uplink communication channels, for example, a Physical Uplink Control Channel (PUCCH) and/or a Physical Uplink Shared Channel (PUSCH). The PDCCH represents an uplink channel that carries control information between the BS 102 and the aggressor UE 106. And the PUSCH represents an uplink channel that carries data information between the BS 102 and the aggressor UE 106. In some embodiments, the aggressor UE 106 can transmit on the UL 152 while the victim UE 104 is receiving on the DL 150 which may cause UL-to-DL interference, also referred to as CLI 154, in the first wireless network 100 between the victim UE 104 and the aggressor UE 106.

As illustrated in FIG. 1B, a second wireless network 120 includes an aggressor BS 122, a first UE 124, a victim BS 126, and a second UE 128. As illustrated in FIG. 1B, the aggressor BS 122 can transmit on a DL 170 to the first UE 124. The DL 170 can include one or more downlink communication channels, for example, the PDCCH and/or the PDSCH. And as illustrated in FIG. 1B, the victim BS 126 can receive on a UL 172 from the second UE 128. The UL 172 can include one or more uplink communication channels, for example, the PUCCH and/or the PUSCH. In some embodiments, the aggressor BS 122 can transmit on the DL 170 while the victim BS 126 is receiving on the UL 172 which may cause CLI 174, in the second wireless network 120 between the aggressor BS 122 and the victim BS 126.

The first wireless network 100 and the second wireless network 120 can be configured to operate based on a wide variety of wireless communication techniques. These techniques can include, but are not limited to, techniques based on 3rd Generation Partnership Project (3GPP) standards. In some embodiments, the BS 102, the aggressor BS 122, and/or the victim BS 126 can include one or more Next Generation Node B Ss (gNBs), one or more radio access nodes (RANs), one or more evolved NodeBs (eNBs), one or more NodeBs, one or more Road Side Units (RSUs), one or more Transmission Reception Points (TRxPs or TRPs), and/or the like. In these embodiments, the BS 102, the aggressor BS 122, and/or the victim BS 126 can include one or more nodes configured to operate based on a wide variety of wireless communication techniques such as, but not limited to, techniques based on 3GPP standards. For example, the BS 102, the aggressor BS 122, and/or the victim BS 126 can include one or more nodes configured to operate using Rel-15, Rel-16, Rel-17, or others.

In some embodiments, the victim UE 104, the aggressor UE 106, the first UE 124, and/or the second UE 128 can include one or more consumer electronics devices, one or more cellular phones, one or more smartphones, one or more feature phones, one or more tablet computers, one or more wearable computer devices, one or more personal digital assistants (PDAs), one or more pagers, one or more wireless handsets, one or more desktop computers, one or more laptop computers, one or more in-vehicle infotainments (IVIs), one or more in-car entertainment (ICEs) devices, one or more Instrument Clusters (ICs), one or more head-up display (HUD) devices, one or more onboard diagnostic (OBD) devices, one or more dashtop mobile equipments (DMEs), one or more mobile data terminals (MDTs), one or more Electronic Engine Management Systems (EEMSs), one or more electronic/engine control units (ECUs), one or more electronic/engine control modules (ECMs), one or more embedded systems, one or more microcontrollers, one or more control modules, one or more engine management systems (EMSs), one or more networked or “smart” appliances, one or more Machine-Type-Communication (MTC) devices, one or more Machine-to-Machine (M2M) devices, one or more Internet of Things (IoT) devices, and the like. In these embodiments, the victim UE 104, the aggressor UE 106, the first UE 124, and/or the second UE 124 can be configured to operate based on a wide variety of wireless communication techniques such as, but not limited to, techniques based on 3GPP standards. For example, the victim UE 104, the aggressor UE 106, the first UE 124, and/or the second UE 124 can be configured to operate using Rel-15, Rel-16, Rel-17, or others.

Because of the large transmit power discrepancy between UL and DL, for example, between the DL 150 and the UL 152 and/or between the DL 170 and the UL 172, and/or propagation conditions, CLI can be detrimental to performance of the first wireless network 100 and/or the second wireless network 120. The CLI within the first wireless network 100 and/or the second wireless network 120 can be measured and reported by the victim UE 104 and/or the aggressor UE 104 as illustrated in FIG. 1A and/or the aggressor BS 122 and/or the victim BS 126 as illustrated in FIG. 1B. Although the discussion of measuring and reporting the CLI within the wireless network is to be described below in terms of measuring and reporting by the victim UE 104, those skilled in the relevant art(s) will recognize that the aggressor UE 104, the aggressor BS 122, and/or the victim BS 126 can measure and report the CLI within the wireless network in a substantially similar manner as the victim UE 104 without departing from the spirit and scope of the present disclosure.

The BS 102 and the victim UE 104 can undergo a handshaking procedure to negotiate generating and reporting of a CLI report of the CLI within the wireless network 100. As part of this handshaking procedure, the BS 102 can send a CLI report configuration within the wireless network 100 to indicate one or more BSs and/or UEs within the wireless network 100, such as the victim UE 104, are to generate and to report the CLI report to the BS 102. In some embodiments, the BS 102 can transmit and/or the victim UE 104 can receive the CLI report configuration on Layer 1 signaling, such as Downlink Control Information (DCI) on the PDCCH to provide an example, and/or Layer 2 signaling, such as a DL Media Access Control-Control Element (MAC-CE) to provide an example. In some embodiments, the DCI can provide the victim UE 104 with information, such physical layer resource allocation, power control commands, and/or Hybrid Automatic Repeat Request (HARD) information to provide some examples. In these embodiments, the DCI can be transmitted on the PDCCH in one or more DCI formats, such as DCI Format 0_0, DCI Format 0_1, DCI Format 1_0, DCI Format 1_1, DCI Format 2_0, DCI Format 2_1, DCI Format 2_2, and/or DCI Format 2_3 as outlined by the 3GPP standards to provide some examples.

In some embodiments, the BS 102 can annex, or encode, the CLI report configuration onto other measurement configurations for one or more other measurement reports that are outlined by the 3GPP standards, for example, a Channel State Information (CSI) report configuration for a CSI report or a Hybrid Automatic Repeat Request (HARQ) report. For example, the BS 102 can annex, or encode, the CLI report configuration to the CSI report configuration and/or the HARQ report configuration to identify the one or more CLI measurements to be performed by the victim UE 104 on the one or more CLI measurement resources. In these embodiments, the BS 102 can provide these other measurement configurations to the victim UE 104 on Layer 1 signaling, such as DCI on the PDDCH to provide an example. Alternatively, or in addition to, the BS 102 can insert a new bit-field, for example, a CLI Report Indication, into the DCI and/or the victim UE 104 can insert the CLI Report Indication into Uplink Control Information (UCI) to indicate the generating and the reporting of the CLI report. Here, the term new bit-field, new field, new symbol, or the like refers to bit-field, field, symbol, or the like that is not outlined by the 3GPP standards. In some embodiments, the victim UE 104 utilizes the CLI Report Indication to advertise its capability to annex, or encode, the CLI report onto the one or more other measurement reports that are outlined by the 3GPP standards, for example, the CSI report. In some embodiments, the BS 102 can insert the CLI report configuration into the CLI Report Indication on the PDSCH, for example, as part of the PDSCH scheduling, to indicate that the victim UE 104 is to generate and to report the CLI report. Alternatively, or in addition to, the BS 102 can insert the CLI report configuration into the CLI Report Indication of a blank DCI, for example, without the PDSCH scheduling, to indicate that the victim UE 104 is to generate and to report the CLI report.

In some embodiments, the CLI report configuration can be used to configure the victim UE 104 to generate and send the CLI report to the BS 102 that outlines the CLI within the wireless network 100. The CLI report configuration can include one or more CLI reporting parameters to be used by the victim UE 104 to generate and to report the CLI report to the BS 102. The one or more CLI reporting parameters can identify the one or more CLI measurement resources to be measured and reported by the victim UE 104. In some embodiments, the one or more CLI reporting parameters can include one or more CLI measurement identifiers (IDs), such as one or more CLI resource indexes to provide an example, to identify the one or more CLI measurement resources to be measured and reported by the victim UE 104. In these embodiments, the one or more CLI measurements can include a CLI-reference signal received power (CLI-RSRP), a CLI-received signal strength indicator (CLI-RSSI), a CLI-reference signal received quality (CLI-RSRQ), a CLI-signal-to-interference-plus-noise ratio (CLI-SINR), or the like to provide some examples. In some embodiments, the one or more CLI reporting parameters can further identify one or more instances in time, also referred to as one or more CLI measurement occasions, in which the victim UE 104 is to measure the one or more CLI measurement resources identified in the one or more CLI reporting parameters. In some embodiments, the one or more CLI reporting parameters can even further identify one or more Layer 1 resources on the PUCCH and/or PUSCH to be used by the victim UE 104 to send the CLI report. In these embodiments, the number of one or more CLI measurement occasions identified in the CLI report can be subject to the capabilities of the victim UE 104. For example, the CLI report can identify fewer CLI measurement occasions, for example, one measurement occasion, for less capable UEs as compared to more capable UEs that can perform two measurement occasions. In these embodiments, the victim UE 104 can inform the BS 102 of its capabilities in a capability signaling as part of the handshaking procedure as described above. In some embodiments, the one or more CLI reporting parameters can yet further identify a CLI report type, for example, periodic, aperiodic, or semi-persistent, to be measured and reported by the victim UE 104.

After processing the CLI report configuration, the victim UE 104 can measure the one or more CLI measurement resources performed over the one or more CLI measurement occasions as identified in the CLI report configuration to generate one or more CLI measurements.

The victim UE 104 generates the CLI report that includes the one or more CLI measurements. The victim UE 104 can provide the CLI report to the BS 102 on Layer 1 signaling, such as UCI on the PUCCH and/or the PUSCH and/or Layer 2 signaling, such as a UL MAC-CE on the PUCCH to provide an example. In some embodiments, the PUCCH resources and/or the PUSCH resources to be used by the victim UE 104 to send the CLI report can be identified in the CLI report configuration. In some embodiments, the victim UE 104 can provide the CLI report along with other measurement reports that are outlined by the 3GPP standards. In these embodiments, the victim UE 104 can report the CLI-RSRP, the CLI-RSSI, the CLI-RSRQ, the CLI-SINR, or the like in the CLI report and Channel Quality Information (CQI), Precoding Matrix Indicator (PMI), CSI-RS Resource Indicator (CRI), SS/PBCH Resource Block Indicator (SSBRI), Layer Indicator (LI), Rank Indicator (RI), or the like in the CSI report. In these embodiments, the victim UE 104 can multiplex the CLI report on the PUSCH in a substantially similar manner as these other measurement reports that are outlined by the 3GPP standards, for example, by CSI multiplexing on the PUSCH. In some embodiments, the victim UE 104 can report the CLI report to the BS 102 on the PUCCH and/or the PUSCH as indicated by Layer 1 signaling, such as DCI on the PDDCH. In these embodiments, the victim UE 104 can annex, or encode, the CLI report within the Hybrid Automatic Repeat Request—Acknowledgement (HARQ-ACK) for the PDSCH and can report the CLI report to the BS 102 over the same PUCCH indicated by DCI for HARQ-ACK. Alternatively, or in addition to, the victim UE 104 can report the CLI report to the BS 102 over a separate PUCCH and/or a separate PUSCH than the PUCCH, respectively, indicated by the DCI for HARQ-ACK. In some embodiments, the victim UE 104 can report the CLI report to the BS 102 on the PUSCH as indicated by Layer 2 signaling, such as a DL MAC-CE, for example.

### Exemplary Timeline Generating and Reporting an Exemplary CLI Report within the Exemplary Wireless Networks

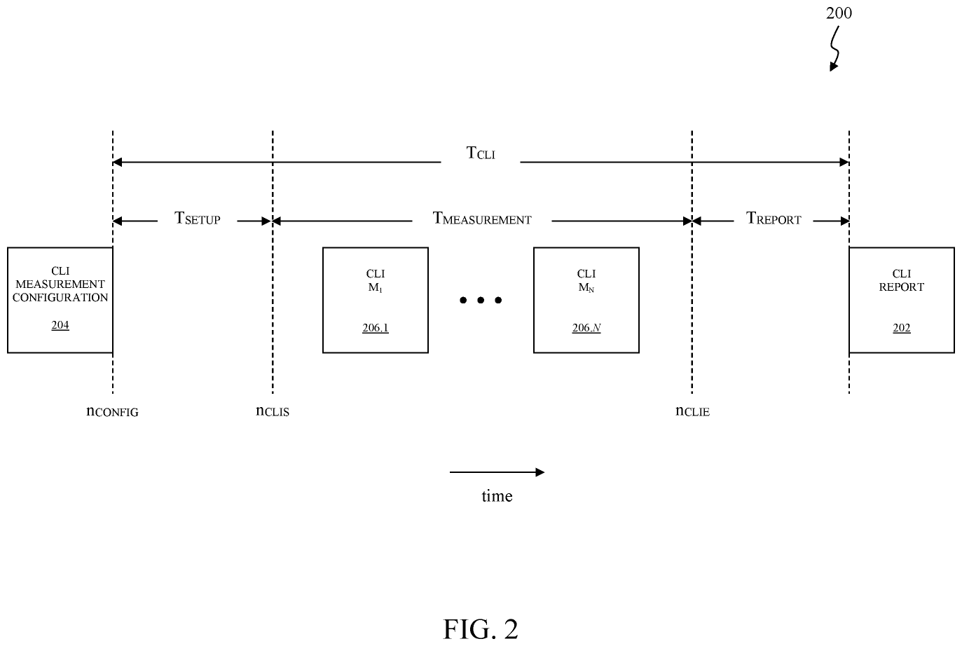

FIG. 2 graphically illustrates an exemplary timeline for generating and reporting an exemplary CLI report within the exemplary wireless networks in accordance with various embodiments of the present disclosure. In the exemplary embodiment illustrated in FIG. 2, an electronic device, such as the victim UE 102 and/or the aggressor UE 104 as illustrated in FIG. 1A and/or the aggressor BS 122 and/or the victim BS 126 as illustrated in FIG. 1B, can measure and report CLI within the wireless network. FIG. 2 illustrates an exemplary timeline 200 to be used by the electronic device to generate and to report a CLI report 202 of the CLI within the wireless network.

The electronic device and another electronic device, such as the BS 102 to provide an example, within the wireless network can perform a handshaking process to negotiate generating and reporting of the CLI report 202 by the electronic device. As part of this handshaking process, the electronic device and the other electronic device can negotiate a generating and report time, T_{CLI}, to be allocated to the electronic device to generate and to report the CLI report 202 to the other electronic device. In some embodiments, the other device starts to scan the wireless network for the CLI report 202 upon expiration of the generating and report time T_{CLI}. As illustrated in FIG. 2, the generating and report time T_{CLI} can include a setup time, T_{SETUP}, to configure the electronic device in accordance with a CLI report configuration 204, a measurement time, T_{MEASURE}, to measure one or more CLI measurement resources within the CLI report configuration 204, and a report time, T_{REPORT}, to generate the CLI report 202 of the one or more CLI measurement resources, each of which is to be described in further detail below. In some embodiments, the setup time T_{SETUP}, the measurement time T_{MEASURE}, and the report time T_{REPORT} can be provided by to the electronic device on Layer 1 signaling, such as DCI on the PDCCH, and/or Layer 2 signaling, such as a DL MAC-CE on the PDSCH to provide an example, as part of the CLI report configuration 204.

As illustrated in FIG. 2, the electronic device can receive a CLI report configuration 204 from another electronic device, such as the BS 102 to provide an example, within the wireless network. In some embodiments, the electronic device can receive the CLI report configuration 204 on Layer 1 signaling, such as DCI on the PDCCH, and/or Layer 2 signaling, such as a DL MAC-CE on the PDSCH to provide an example. In some embodiments, the setup time T_{SETUP} can be used to configure the electronic device to measure the CLI measurements CLI M₁ 206.1 through CLI M_{N} 206.N. In these embodiments, the CLI report configuration 204 can identify one or more CLI reporting parameters to be used by the electronic device to generate and to report the CLI report 202 to the other electronic device. The one or more CLI reporting parameters can identify the one or more CLI measurement resources to be measured and reported by the electronic device; the one or more CLI measurements to be performed on the one or more CLI measurement resources; one or more CLI measurement occasions in which the electronic device is to measure the one or more CLI measurement resources; one or more resources, such as one or more Layer 1 resources in the PUCCH and/or PUSCH to provide an example, to be used by the electronic device to report the CLI report 202; and/or a CLI report type to be measured and reported by the electronic device.

After receiving the CLI report configuration 204, the electronic device processes the CLI report configuration 204 to identify the one or more CLI reporting parameters to be used by the electronic device to generate and to report the CLI report 202 to the other electronic device during the setup time T_{SETUP}. As illustrated in the exemplary timeline 200, the setup time T_{SETUP} represents an instance of time between a last symbol of the CLI report configuration 204, denoted as n_{CONFIG}, and a first symbol of a CLI measurement resource, denoted as n_{CLIS}, that is to be measured by the electronic device. During the setup time T_{SETUP}, the electronic device recovers the one or more CLI reporting parameters from the CLI report configuration 204 and is configured in accordance with the one or more CLI reporting parameters to generate and to report the CLI report 202. In some embodiments, the electronic device can identify the control channels, such as the PDCCH or the PUCCH to provide some examples, data channels, such as the PDSCH or the PUSCH to provide some examples, and/or signals, such as demodulation reference signal (DMRS), a phase-tracking reference signal (PTRS), a sounding reference signal (SRS), or a channel-state information reference signal (CSI-RS) to provide some examples, that carry the one or more CLI measurement resources. In some embodiments, the electronic device can be configured to measure a CLI-reference signal received power (CLI-RSRP), a CLI-received signal strength indicator (CLI-RSSI), a CLI-reference signal received quality (CLI-RSRQ), a CLI-signal-to-interference-plus-noise ratio (CLI-SINR), or the like to provide some examples, as identified by the one or more CLI reporting parameters.

After being configured to measure the one or more CLI measurement resources as outlined in the CLI report configuration 204, the electronic device performs the measurements on the one or more CLI measurement resources over one or more CLI measurement occasions as identified in the one or more CLI reporting parameters to generate CLI measurements CLI M₁ 206.1 through CLI M_{N} 206.N as illustrated in FIG. 2, during the measurement time T_{MEASURE}. In some embodiments, the measurement time T_{MEASURE} represents an instance of time between the first symbol of the CLI measurement resource n_{CLIS} and a last symbol of the CLI measurement resource, denoted as n_{CLIE}.

After generating the CLI measurements CLI M₁ 206.1 through CLI M_{N} 206.N, the electronic device generates the CLI report 202 of the CLI measurements CLI M₁ 206.1 through CLI M_{N} 206.N. As illustrated in FIG. 2, the electronic device generates the CLI report 202 during the report time T_{REPORT}. After expiration of the report time T_{REPORT}, the electronic device reports the CLI report 202 to the other electronic device. In some embodiments, the electronic device reports the CLI report 202 to the other electronic device as identified by the one or more CLI reporting parameters. In these embodiments, the one or more CLI reporting parameters can identify that the CLI report 202 is to be reported on Layer 1 signaling, such as UCI on the PUCCH and/or the PUSCH, and/or Layer 2 signaling, such as a UL MAC-CE on the PUCCH to provide an example. In these embodiments, one or more CLI reporting parameters can identify PUCCH resources and/or the PUSCH resources to be used by the electronic device to report the CLI report 202 to the other electronic device.

### Exemplary Layer 1 Signaling within the Generating and Reporting of the Exemplary CLI Report

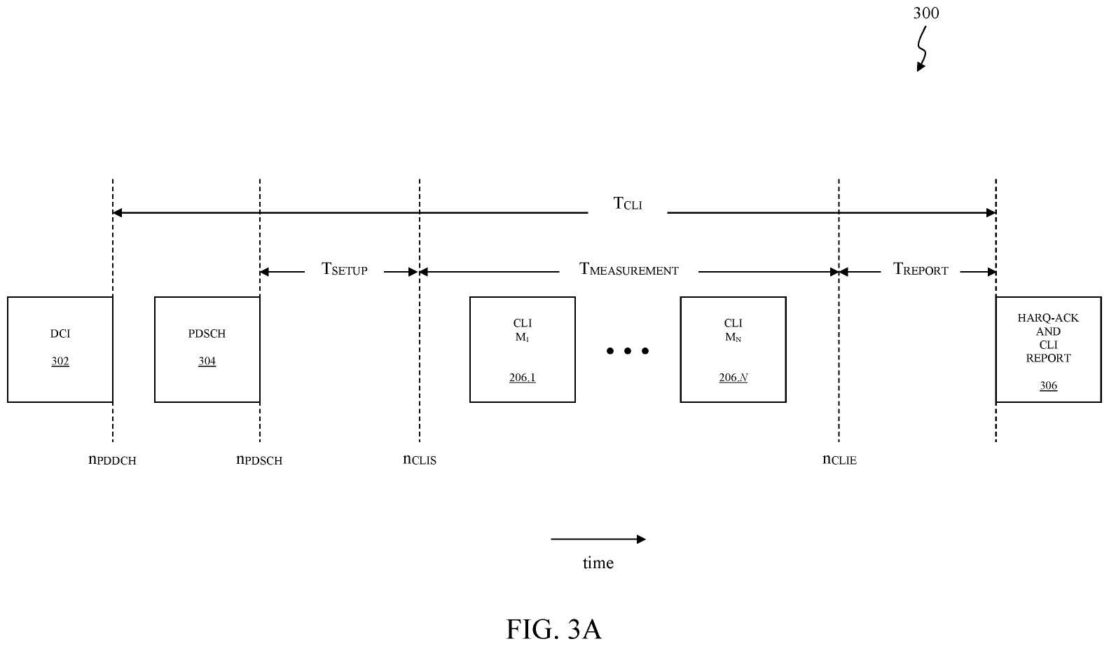

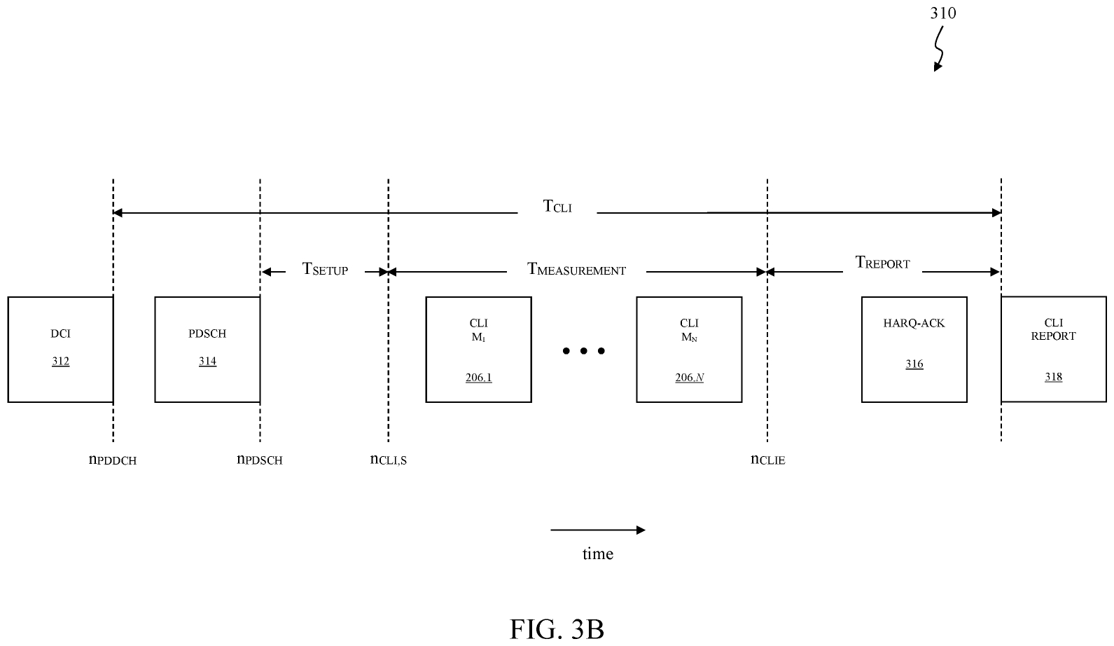

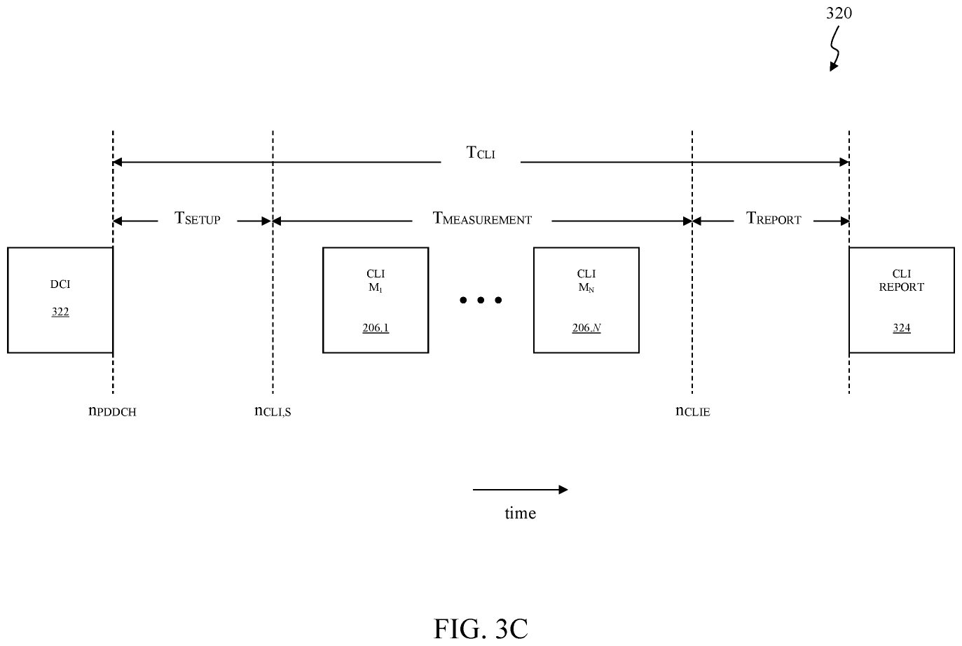

FIG. 3A through FIG. 3C graphically illustrate exemplary timelines for exemplary Layer 1 signaling within the generating and the reporting of the exemplary CLI report in accordance with various embodiments of the present disclosure. In the exemplary embodiments illustrated in FIG. 3A through FIG. 3C, a new bit-field, for example, a CLI Report Indication, can be inserted into Layer 1 signaling, such as DCI on the PDCCH to provide an example. The CLI Report Indication can indicate that an electronic device to generate and report a CLI report of the CLI within a wireless network, such as the wireless network 100 and/or the wireless network 120 As to be described in further detail below, the CLI Report Indication can include a CLI report configuration to identify one or more CLI reporting parameters to be used by the electronic device to generate and to report the CLI report. The one or more CLI reporting parameters can identify the one or more CLI measurement resources to be measured and reported by the electronic device; the one or more CLI measurements to be performed on the one or more CLI measurement resources; one or more CLI measurement occasions in which the electronic device is to measure the one or more CLI measurement resources; one or more resources, such as one or more Layer 1 resources in the PUCCH and/or PUSCH to provide an example, to be used by the electronic device to report the CLI report; and/or a CLI report type to be measured and reported by the electronic device.

An exemplary timeline 300 as illustrated in FIG. 3A, an exemplary timeline 310 as illustrated in FIG. 3B, and an exemplary timeline 320 as illustrated in FIG. 3C can represent exemplary embodiments of the exemplary timeline 200 as described above in FIG. 2. As such, the exemplary timeline 300, the exemplary timeline 310, and the exemplary timeline 320 share many substantially features as the exemplary timeline 200 as described above in FIG. 2. Therefore, only differences between the exemplary timeline 300, the exemplary timeline 310, and the exemplary timeline 320 and the exemplary timeline 200 as described above in FIG. 2 are to be described in further detail below.

The exemplary timeline 300 as illustrated in FIG. 3A and the exemplary timeline 310 as illustrated in FIG. 3B represent timelines in which the indication to generate and to report the CLI report can be included as part of DL PDSCH scheduling. These timelines can utilized by the electronic device to simultaneously process the PDSCH 304 and the CLI measurements CLI M₁ 206.1 through CLI M_{N} 206.N. As illustrated in FIG. 3A and FIG. 3B, the electronic device can receive the CLI report configuration on Layer 1 signaling, such as DCI 302 on the PDCCH as part of scheduling the PDSCH 304. In some embodiments, the DCI 302 can include the new bit-field, for example, the CLI Report Indication as described above in FIG. 1 and/or FIG. 2, to indicate that the electronic device is to generate and to report the CLI report. In some embodiments, the DCI 302 can simultaneously indicate, along with the CLI Report Indication, which HARQ process is to be used by the electronic device in recovering and/or decoding user data on the PDSCH 304. In these embodiments, the DCI 302 can include a New Data Indicator (NDI) bit to indicate whether the user data on the PDSCH 304 is new user data or a re-transmission of previous user data. In some embodiments, upon scheduling the PDSCH 304, the electronic device can check the NDI bit to determine whether the user data on the PDSCH 304 is the new user data or the re-transmission of previous user data. In these embodiments, the electronic device can calculate a checksum of the user data on the PDSCH 304 and can report a HARQ report indicating an acknowledgement (ACK) or no acknowledgement (NACK) of the user data on the PDSCH 304 as outlined by the 3GPP standards.

In some embodiments, a difference in time between a last symbol of the DCI 302, denoted as n_{PDCCH}, and n_{CLI,S} can be greater than a minimum time gap N₀ between a last symbol of the DCI 302 and a first symbol of the CLI measurements CLI M₁ 206.1 through CLI M_{N} 206.N. In some embodiments, the minimum time gap N₀ can be subject to the capabilities of the electronic device. In some embodiments, a maximum time between n_{PDCCH} and n_{CLI,S} can be greater than a PDSCH processing time Ni that is scaled by a processing time scaling factor d. In these embodiments, the PDSCH processing time Ni can be outlined by the 3GPP standards and the processing time scaling factor d represents a new parameter that is not outlined by the 3GPP standards. The scaling factor d, which can be subject to the capabilities of the electronic device, is related to simultaneously processing of the PDSCH 304 and the CLI measurements CLI M₁ 206.1 through CLI M_{N} 206.N. In some embodiments, the scaling factor d can be dependent upon whether the one or more CLI measurement resources identified in the CLI report configuration overlap in time and/or frequency with the user data on the PDSCH 304. In these embodiments, when the one or more CLI measurement resources identified in the CLI report configuration overlap in time and/or frequency with the user data on the PDSCH 304, the user data on the PDSCH 304 can be rate matched and/or punctured as outlined by the 3GPP standards.

After processing the DCI 302 and the PDSCH 304 over the setup time T_{SETUP} in a substantially similar manner as described above in FIG. 2, the electronic device performs the measurements on the one or more CLI measurement resources over one or more CLI measurement occasions as identified in the one or more CLI reporting parameters to generate CLI measurements CLI M₁ 206.1 through CLI M_{N} 206.N over the measurement time T_{MEASURE} in a substantially similar manner as described above in FIG. 2.

After generating the CLI measurements CLI M₁ 206.1 through CLI M_{N} 206.N, the electronic device generates the CLI report of the CLI measurements CLI M₁ 206.1 through CLI M_{N} 206.N. As illustrated in FIG. 3A, the electronic device can annex, or encode, the CLI report within the HARQ-ACK or the HARQ-NACK and can report the CLI report over the same PUCCH indicated by the DCI 302 for HARQ-ACK, denoted as HARQ-ACK and CLI Report 306 in FIG. 3A. Otherwise, as illustrated in FIG. 3B, the electronic device can report the CLI report over a separate PUCCH, denoted as CLI report 318, than the PUCCH indicated by the DCI 302 for HARQ-ACK, denoted as HARQ-ACK 312 316 in FIG. 3B. In some embodiments, the identification of the separate PUCCH for the CLI report 314 can be received by the electronic device on higher layer signaling, such as Radio Resource Control (RRC) signaling and/or Non-Access Stratum (NAS) signaling to provide some examples. In these embodiments, the higher layer signaling can indicate a time offset N_{OFF} between the HARQ-ACK 312 and the CLI report 314. In some embodiments, the time offset N_{OFF} can be used by electronic device to determine a processing time N_{P} between a last symbol of the CLI measurements CLI M₁ 206.1 through CLI M_{N} 206.N to a first symbol of PUCCH carrying the CLI report 314.

The exemplary timeline 320 as illustrated in FIG. 3C represents a timeline in which the indication to generate and to report the CLI report can be included on a blank DCI 322, for example, which does not include the PDSCH scheduling. As illustrated in FIG. 3C, the electronic device can receive the CLI report configuration on Layer 1 signaling, such as the blank DCI 322 on the PDCCH without the scheduling of the PDSCH 304 as described above in FIG. 3A and FIG. 3B. In some embodiments, the blank DCI 322 can include existing bit-fields, such as time domain resource allocation (TDRA), frequency domain resource allocation (FDRA), virtual to physical resource mapping, modulation and coding scheme (MCS), UL frequency hopping parameters, HARQ process number (HPN), new data indicator (NDI), redundancy version (RV), transmission power control (TPC), PDSCH-to-HARQ feedback timing, and/or downlink assignment index (DAI) to provide some examples, that are outlined by the 3GPP standards. In these embodiments, these existing bit-fields can be re-purposed to indicate that the electronic device is to generate and to report the CLI report. For example, these existing bit-fields can be assigned to invalid combinations of bits with respect to the 3GPP standards to thereby indicate that the electronic device is to generate and to report the CLI report.

After generating the CLI measurements CLI M₁ 206.1 through CLI M_{N} 206.N, the electronic device generates a CLI report 324 of the CLI measurements CLI M₁ 206.1 through CLI M_{N} 206.N. As illustrated in FIG. 3C, the electronic device reports the CLI report 324 on Layer 1 signaling, such as UCI on the PUCCH to provide an example. In these embodiments, one or more CLI reporting parameters can identify PUCCH resources to be used by the electronic device to report the CLI report 324.

### Exemplary Layer 2 Signaling within the Generating and Reporting of the Exemplary CLI Report

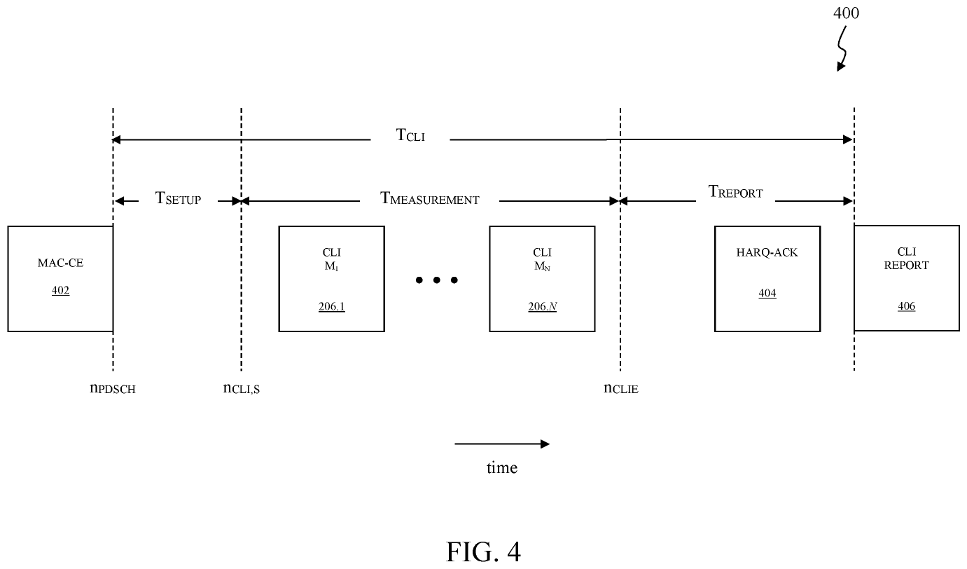

FIG. 4 graphically illustrate an exemplary timeline for exemplary Layer 2 signaling within the generating and the reporting of the exemplary CLI report in accordance with various embodiments of the present disclosure. In the exemplary embodiments illustrated in FIG. 4, Layer 2 signaling, such as a DL Media Access Control-Control Element (MAC-CE) to provide an example, can be used to indicate that an electronic device, such as the victim UE 102 and/or the aggressor UE 104 and/or the aggressor BS 122, and/or the victim BS 126, is to generate and to report a CLI report of the CLI within a wireless network, such as the wireless network 100 and/or the wireless network 120. As to be described in further detail below, the DL MAC-CE can include a CLI report configuration to identify one or more CLI reporting parameters to be used by the electronic device to generate and to report the CLI report. The one or more CLI reporting parameters can identify the one or more CLI measurement resources to be measured and reported by the electronic device; the one or more CLI measurements to be performed on the one or more CLI measurement resources; one or more CLI measurement occasions in which the electronic device is to measure the one or more CLI measurement resources; one or more resources, such as one or more Layer 1 resources in the PUCCH and/or PUSCH to provide an example, to be used by the electronic device to report the CLI report; and/or a CLI report type to be measured and reported by the electronic device. An exemplary timeline 400 as illustrated in FIG. 4 can represent an exemplary embodiment of the exemplary timeline 200 as described above in FIG. 2. As such, the exemplary timeline 400 shares many substantially features as the exemplary timeline 200 as described above in FIG. 2. Therefore, only differences between the exemplary timeline 400 and the exemplary timeline 200 as described above in FIG. 2 are to be described in further detail below.

As illustrated in FIG. 4, the electronic device can receive a DL MAC-CE 402 including a CLI report configuration on the PDSCH. As described above, the CLI report configuration can identify one or more Layer 1 resources in the PUCCH and/or PUSCH to provide an example, to be used by the electronic device to report the CLI report. Alternatively, or in addition to, higher layer signaling, such as Radio Resource Control (RRC) signaling and/or Non-Access Stratum (NAS) signaling to provide some examples, can be used to identify the one or more resources to be used by the electronic device to report the CLI report. In these embodiments, these resources can be preconfigured with, for example, the higher layer signaling indicating one or more indexes associated with these resources.

In some embodiments, the DL MAC-CE 402 can simultaneously indicate, along with the CLI report configuration, which HARQ process is to be used by the electronic device in recovering and/or decoding user data on the PDSCH. In these embodiments, the DL MAC-CE 402 can include the NDI bit, as described above in FIG. 3A through FIG. 3C, to indicate whether the user data on the PDSCH is new user data or a re-transmission of previous user data. In some embodiments, upon scheduling the PDSCH, the electronic device can check the NDI bit to determine whether the user data on the PDSCH is the new user data or the re-transmission of previous user data. In these embodiments, the electronic device can calculate a checksum of the user data on the PDSCH and can report a HARQ report indicating an acknowledgement (ACK) or no acknowledgement (NACK) of the user data on the PDSCH as outlined by the 3GPP standards.

After generating the CLI measurements CLI M₁ 206.1 through CLI M_{N} 206.N, the electronic device generates the CLI report of the CLI measurements CLI M₁ 206.1 through CLI M_{N} 206.N, the electronic device can report the CLI report 406 over the same PUSCH indicated by the DL MAC-CE 402 for HARQ-ACK, denoted as HARQ-ACK 404 in FIG. 4. In some embodiments, the electronic device can report the HARQ-ACK 404 on a slot n on the PUSCH and the CLI report 406 on a slot n+3Nₛₗₒₜ^{subframe,μ}+1, wherein μ represents the Subcarrier Spacing configuration for the PUCCH as outlined by the 3GPP standards.

### Exemplary Methods for CLI Measuring and Reporting

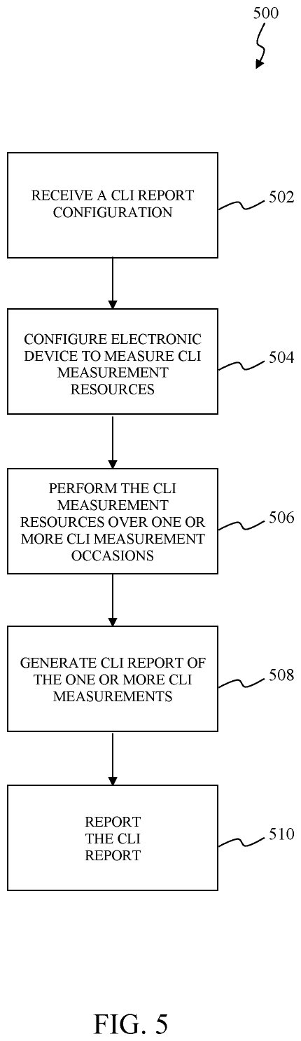

FIG. 5 illustrates a flowchart of an exemplary operation for generating and reporting the exemplary CLI report within the exemplary wireless networks in accordance with various embodiments of the present disclosure. The disclosure is not limited to this operational description. Rather, it will be apparent to ordinary persons skilled in the relevant art(s) that other operational control flows are within the scope and spirit of the present disclosure. The following discussion describes an exemplary operational control flow 500 for generating and reporting a CLI report as described above in FIG. 1A, FIG. 1B, FIG. 2, FIG. 3A through FIG. 3C, and/or FIG. 4. The operational control flow 500 can be executed by an electronic device, such as the victim UE 102 and/or the aggressor UE 104 as illustrated in FIG. 1A and/or the aggressor BS 122 and/or the victim BS 126 as illustrated in FIG. 1B.

At operation 502, the operational control flow 500 can receive a CLI report configuration. In some embodiments, the operational control flow 500 can receive the CLI report configuration on Layer 1 signaling, such as DCI on the PDCCH, and/or Layer 2 signaling, such as a DL MAC-CE on the PDSCH to provide an example, in a substantially similar manner as described above in FIG. 1A, FIG. 1B, FIG. 2, FIG. 3A through FIG. 3C, and/or FIG. 4. In these embodiments, the CLI report configuration can identify one or more CLI reporting parameters to be used by the electronic device to generate and to report the CLI report to the other electronic device. The one or more CLI reporting parameters can identify the one or more CLI measurement resources to be measured and reported by the electronic device; the one or more CLI measurements to be performed on the one or more CLI measurement resources; one or more CLI measurement occasions in which the electronic device is to measure the one or more CLI measurement resources; one or more resources, such as one or more Layer 1 resources in the PUCCH and/or PUSCH to provide an example, to be used by the electronic device to report the CLI report; and/or a CLI report type to be measured and reported by the electronic device.

At operation 504, the operational control flow 500 can configure the electronic device to measure the one or more CLI measurement resources identified in the CLI report configuration from operation 502 in a substantially similar manner as described above in FIG. 1A, FIG. 1B, FIG. 2, FIG. 3A through FIG. 3C, and/or FIG. 4. The operational control flow 500 can recover the one or more CLI reporting parameters as described above in FIG. 1A, FIG. 1B, FIG. 2, FIG. 3A through FIG. 3C, and/or FIG. 4 from the CLI report configuration from operation 502. In some embodiments, the operational control flow 500 can identify the control channels, such as the PDCCH or the PUCCH to provide some examples, data channels, such as the PDSCH or the PUSCH to provide some examples, and/or signals, such as demodulation reference signal (DMRS), a phase-tracking reference signal (PTRS), a sounding reference signal (SRS), or a channel-state information reference signal (CSI-RS) to provide some examples, that carry the one or more CLI measurement resources. In some embodiments, the operational control flow 500 can configure the electronic device to measure a CLI-reference signal received power (CLI-RSRP), a CLI-received signal strength indicator (CLI-RSSI), a CLI-reference signal received quality (CLI-RSRQ), a CLI-signal-to-interference-plus-noise ratio (CLI-SINR), or the like to provide some examples, as identified by the CLI report configuration from operation 502.

At operation 506, the operational control flow 500 can perform one or more CLI measurements on the one or more CLI measurement resources over the one or more CLI measurement occasions identified from operation 504 to generate one or more CLI measurements in a substantially similar manner as described above in FIG. 1A, FIG. 1B, FIG. 2, FIG. 3A through FIG. 3C, and/or FIG. 4.

At operation 508, the operational control flow 500 can generate a CLI report of the one or more CLI measurements from operation 506 in a substantially similar manner as described above in FIG. 1A, FIG. 1B, FIG. 2, FIG. 3A through FIG. 3C, and/or FIG. 4.

At operation 510, the operational control flow 500 can report the CLI report from operation 508 in a substantially similar manner as described above in FIG. 1A, FIG. 1B, FIG. 2, FIG. 3A through FIG. 3C, and/or FIG. 4. In some embodiments, the operational control flow 500 can report the CLI report from operation 508 as identified by the CLI report configuration from operation 502. In these embodiments, the CLI report configuration from operation 502 can identify that the CLI report from operation 508 is to be reported on Layer 1 signaling, such as UCI on the PUCCH and/or the PUSCH, and/or Layer 2 signaling, such as a UL MAC-CE on the PUCCH to provide an example. In these embodiments, the CLI report configuration from operation 502 can identify PUCCH resources and/or the PUSCH resources to be used by the operational control flow 500 to report the CLI report from operation 508.

### Exemplary Electronic Device that can be Implemented within the Exemplary Wireless Networks

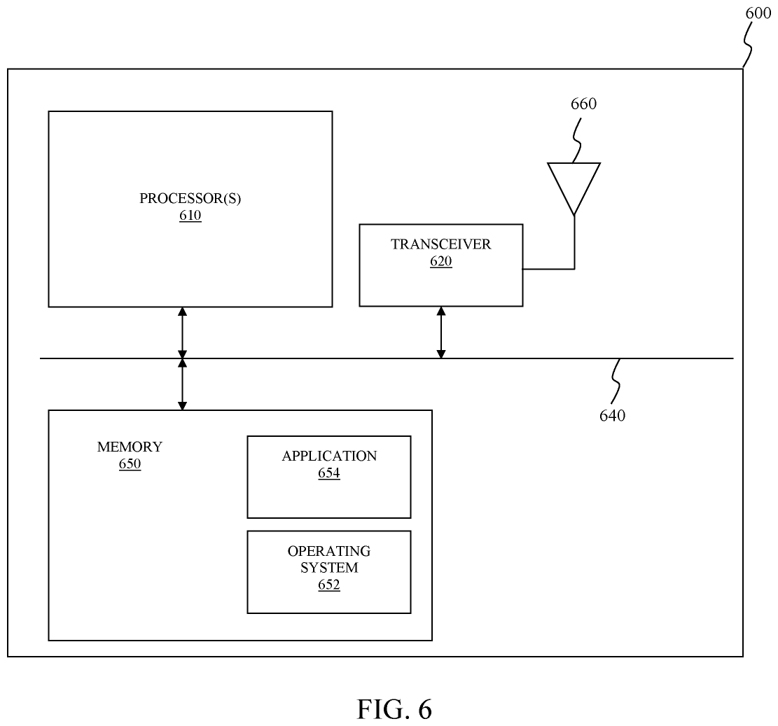

FIG. 6 illustrates a block diagram of an electronic device for generating and reporting the exemplary CLI report within the exemplary wireless networks in accordance with various embodiments of the present disclosure. In the exemplary embodiment illustrated in FIG. 6, an electronic device 600 may be any of the electronic devices, for example, the victim UE 102 and/or the aggressor UE 104 as illustrated in FIG. 1A and/or the aggressor BS 122 and/or the victim BS 126 as illustrated in FIG. 1B. As illustrated in FIG. 6, the electronic device includes one or more processors 610, one or more transceivers 660, a communication infrastructure 640, a memory 650, an operating system 652, an application 654, and an antenna 660. The various systems illustrated in FIG. 6 are provided as exemplary parts of the electronic device 600, and the electronic device 600 can include other circuit(s) and subsystem(s). Also, although the systems of the electronic device 600 are illustrated as separate components, the aspects of this disclosure can include any combination of these, less, or more components. Also, the electronic device 600 can include any number of processors, transceivers, communication infrastructures, memories, operating systems, applications, and antennas.

The memory 650 may include random access memory (RAM) and/or cache, and may include control logic (e.g., computer software) and/or data. The memory 650 may include other storage devices or memory such as, but not limited to, a hard disk drive and/or a removable storage device/unit. According to some examples, the operating system 652 can be stored in the memory 650. The operating system 652 can manage transfer of data between the memory 650, the application 654, the processor 610, and/or the transceiver 660. In some examples, the operating system 652 maintains one or more network protocol stacks (e.g., Internet protocol stack, cellular protocol stack, and the like) that can include a number of logical layers. At corresponding layers of the protocol stack, the operating system 652 includes control mechanism and data structures to perform the functions associated with that layer. In some embodiments, the application 654 can be stored in the memory 650. The application 654 can include applications (e.g., user applications) used by a wireless electronic device and/or a user of the wireless electronic device. The application 654 can include applications such as, but not limited to, radio streaming, video streaming, remote control, and/or other user applications.

The electronic device 600 can also include the communication infrastructure 640. The communication infrastructure 640 provides communication between, for example, the processor 610, the transceiver 660, and the memory 650. In some implementations, the communication infrastructure 640 may be a bus. The processor 610 together with instructions stored in memory 650 can performs operations enabling the electronic device 600 to generate and to report a CLI report as described above in FIG. 1A, FIG. 1B, FIG. 2, FIG. 3A through FIG. 3C, FIG. 4, and/or FIG. 5.

The transceiver 660 can transmit and receive communications signals that support the operations of electronic device including, but not limited to, mitigation for transmitting latency, according to some aspects, and may be coupled to the antenna 660. The antenna 660 may include one or more antennas that may be the same or different types. The transceiver 660 allows the electronic device 600 to communicate with other devices that may be wired and/or wireless. In some examples, the transceiver 660 can include processors, controllers, radios, sockets, plugs, buffers, and like circuits/devices used for connecting to and communication on networks. According to some examples, the transceiver 660 include one or more circuits to connect to and communicate on wired and/or wireless networks. In some embodiments, the transceiver 660 can include a cellular subsystem, a WLAN subsystem, and/or a Bluetooth™ subsystem, each including its own radio transceiver and protocol(s) as will be understood by those skilled arts based on the discussion provided herein. In some implementations, the transceiver 660 can include more or fewer systems for communicating with other devices. In some embodiments, the transceiver 660 can include one or more circuits (including a WLAN transceiver) to enable connection(s) and communication over WLAN networks such as, but not limited to, networks based on standards described in IEEE 802.11. Additionally, or alternatively, the transceiver 660 can include one or more circuits (including a Bluetooth™ transceiver) to enable connection(s) and communication based on, for example, Bluetooth™ protocol, the Bluetooth™ Low Energy protocol, or the Bluetooth™ Low Energy Long Range protocol. For example, transceiver 660n can include a Bluetooth™ transceiver. In some embodiments, the transceiver 660 can include one or more circuits (including a cellular transceiver) for connecting to and communicating on cellular networks. The cellular networks can include, but are not limited to, 3G/4G/5G networks such as Universal Mobile Telecommunications System (UMTS), Long-Term Evolution (LTE), and the like. For example, the transceiver 660a-660n can be configured to operate according to one or more of Rel-15, Rel-16, Rel-17, or other of the 3GPP standards.

In some embodiments, the processor 610, alone or in combination with computer instructions stored within the memory 650, and/or the transceiver 660 can generate and report the CLI report as described above in FIG. 1A, FIG. 1B, FIG. 2, FIG. 3A through FIG. 3C, FIG. 4, and/or FIG. 5.

### Exemplary Computer System that can be Implemented within the Exemplary Wireless Networks

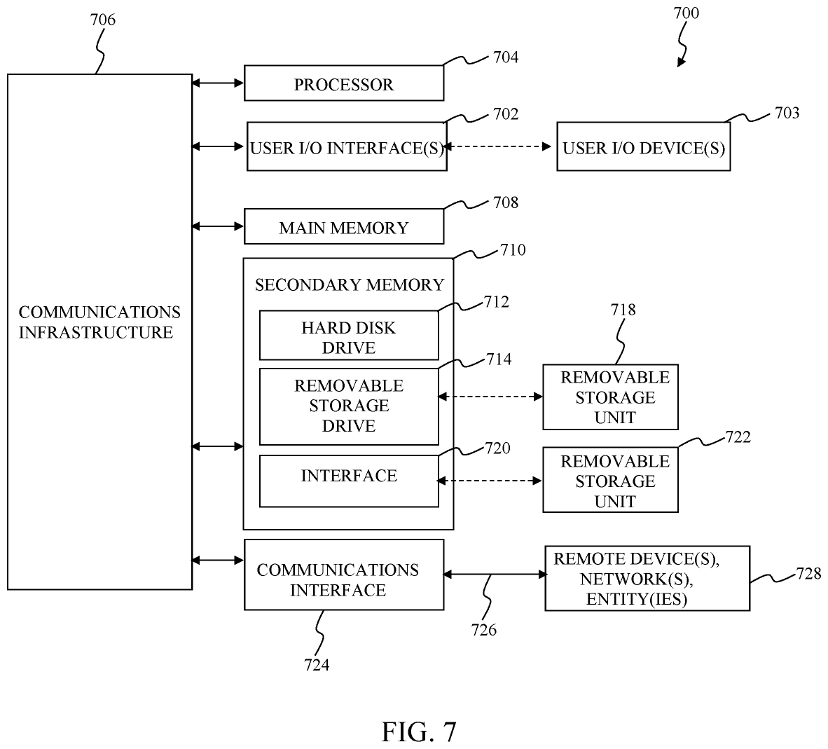

FIG. 7 illustrates a block diagram of an exemplary computer system that can be implemented within the exemplary wireless networks according to some exemplary embodiments of the present disclosure. Computer system 700 can be any well-known computer capable of performing the functions described herein such as the victim UE 102 and/or the aggressor UE 104 as illustrated in FIG. 1A and/or the aggressor BS 122 and/or the victim BS 126 as illustrated in FIG. 1B. Computer system 700 includes one or more processors (also called central processing units, or CPUs), such as a processor 704. Processor 704 is connected to a communication infrastructure 706 (e.g., a bus). Computer system 700 also includes user input/output device(s) 703, such as monitors, keyboards, pointing devices, etc., that communicate with communication infrastructure 706 through user input/output interface(s) 702. Computer system 700 also includes a main or primary memory 708, such as random access memory (RAM). Main memory 708 may include one or more levels of cache. Main memory 708 has stored therein control logic (e.g., computer software) and/or data.

Computer system 700 may also include one or more secondary storage devices or memory 710. Secondary memory 710 may include, for example, a hard disk drive 712 and/or a removable storage device or drive 714. Removable storage drive 714 may be a floppy disk drive, a magnetic tape drive, a compact disk drive, an optical storage device, tape backup device, and/or any other storage device/drive.

Removable storage drive 714 may interact with a removable storage unit 718. Removable storage unit 718 includes a computer usable or readable storage device having stored thereon computer software (control logic) and/or data. Removable storage unit 718 may be a floppy disk, magnetic tape, compact disk, DVD, optical storage disk, and/any other computer data storage device. Removable storage drive 714 reads from and/or writes to removable storage unit 718 in a well-known manner.

According to some aspects, secondary memory 710 may include other means, instrumentalities or other approaches for allowing computer programs and/or other instructions and/or data to be accessed by computer system 700. Such means, instrumentalities or other approaches may include, for example, a removable storage unit 722 and an interface 720. Examples of the removable storage unit 722 and the interface 720 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 700 may further include a communication or network interface 724. Communication interface 724 enables computer system 700 to communicate and interact with any combination of remote devices, remote networks, remote entities, etc. (individually and collectively referenced by reference number 728). For example, communication interface 724 may allow computer system 700 to communicate with remote devices 728 over communications path 726, which may be wired and/or wireless, and which may include any combination of LANs, WANs, the Internet, etc. Control logic and/or data may be transmitted to and from computer system 700 via communication path 726.

The operations in the preceding aspects can be implemented in a wide variety of configurations and architectures. Therefore, some or all of the operations in the preceding aspects may be performed in hardware, in software or both. In some aspects, a tangible, non-transitory apparatus or article of manufacture includes a tangible, non-transitory computer useable or readable medium having control logic (software) stored thereon is also referred to herein as a computer program product or program storage device. This includes, but is not limited to, computer system 700, main memory 708, secondary memory 710 and removable storage units 718 and 722, as well as tangible articles of manufacture embodying any combination of the foregoing. Such control logic, when executed by one or more data processing devices (such as computer system 700), causes such data processing devices to operate as described herein.

Based on the teachings contained in this disclosure, it will be apparent to persons skilled in the relevant art(s) how to make and use aspects of the disclosure using data processing devices, computer systems and/or computer architectures other than that shown in FIG. 7. In particular, aspects may operate with software, hardware, and/or operating system implementations other than those described herein.

### CONCLUSION

Embodiments of the disclosure can be implemented in hardware, firmware, software application, or any combination thereof. Embodiments of the disclosure can also be implemented as instructions stored on one or more computer-readable mediums, which can be read and executed by one or more processors. A computer-readable medium can include any mechanism for storing or transmitting information in a form readable by a computer (e.g., a computing circuitry). For example, a computer-readable medium can include non-transitory computer-readable mediums such as read only memory (ROM); random access memory (RAM); magnetic disk storage media; optical storage media; flash memory devices; and others. As another example, the computer-readable medium can include transitory computer-readable medium such as electrical, optical, acoustical, or other forms of propagated signals (e.g., carrier waves, infrared signals, digital signals, etc.). Further, firmware, software application, routines, instructions have been described as performing certain actions. However, it should be appreciated that such descriptions are merely for convenience and that such actions in fact result from computing devices, processors, controllers, or other devices executing the firmware, software application, routines, instructions, etc.

It is to be appreciated that the Detailed Description section, and not the Summary and Abstract sections, is intended to be used to interpret the claims. The Summary and Abstract sections may set forth one or more but not all exemplary embodiments of the disclosure as contemplated by the inventor(s), and thus, are not intended to limit the disclosure and the appended claims in any way.

The disclosure has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the disclosure that others can, by applying knowledge within the skill of the art, readily modify and/or adapt for various applications such specific embodiments, without undue experimentation, without departing from the general concept of the disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan considering the teachings and guidance.

The breadth and scope of the disclosure should not be limited by any of the above-described exemplary embodiments but should be defined only in accordance with the following claims and their equivalents.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should only occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the United States, collection of, or access to, certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

What is claimed is:

1. A method for generating and reporting a cross link interference (CLI) report in a wireless network, the method comprising:
receiving, by an electronic device within the wireless network, a CLI report configuration;
configuring the electronic device to measure a CLI resource identified in the CLI report configuration;
performing, by the electronic device, a CLI measurement of a CLI resource identified in the CLI report configuration over one or more of CLI measurement occasions identified in the CLI report configuration to provide one or more CLI measurements;
generating, by the electronic device, a CLI report of the one or more CLI measurements; and
reporting, by the electronic device, the CLI report to another electronic device within the wireless network.

2. The method of claim 1, wherein the receiving comprises receiving the CLI report configuration on Layer 1 signaling.

3. The method of claim 2, wherein the Layer 1 signaling comprises Downlink Control Information (DCI) on a Physical Downlink Control Channel (PDCCH) as part of scheduling a Physical Downlink Shared Channel (PDSCH).

4. The method of claim 1, wherein the receiving comprises receiving the CLI report configuration on Layer 2 signaling.

5. The method of claim 4, wherein the Layer 2 signaling comprises a Media Access Control-Control Element (MAC-CE) on a Physical Downlink Shared Channel (PDSCH).

6. The method of claim 1, wherein the performing comprises measuring a CLI-reference signal received power (CLI-RSRP), a CLI-received signal strength indicator (CLI-RSSI), a CLI-reference signal received quality (CLI-RSRQ), or a CLI-signal-to-interference-plus-noise ratio (CLI-SINR) of the CLI resource.

7. The method of claim 1, wherein the reporting comprises reporting the CLI report configuration on Layer 1 signaling.

8. The method of claim 7, wherein the Layer 1 signaling comprises resources of a Physical Uplink Control Channel (PUCCH) that are identified by the CLI report configuration that are similarly identified by Downlink Control Information (DCI) for use for a Hybrid Automatic Repeat Request (HARD) report.

9. The method of claim 1, wherein the reporting comprises reporting the CLI report configuration on Layer 2 signaling.

10. The method of claim 9, wherein the Layer 2 signaling comprises a Media Access Control-Control Element (MAC-CE) on resources of a Physical Uplink Shared Channel (PUSCH) identified in the CLI report configuration.

11. An electronic device, comprising:
a transceiver configured to receive Downlink Control Information (DCI) having a CLI report configuration; and
a processor, coupled to the transceiver, configured to:
perform a CLI measurement of a CLI resource identified in the CLI report configuration over one or more CLI measurement occasions identified in the CLI report configuration to provide one or more CLI measurements, and
generate a CLI report of the one or more CLI measurements,
wherein the transceiver is further configured to report the CLI report on a Physical Uplink Control Channel (PUCCH) identified in the CLI report configuration.

12. The electronic device of claim 11, wherein the DCI comprises a new bit-field that is not outlined in a 3rd Generation Partnership Project (3GPP) standard that includes the CLI report configuration.

13. The electronic device of claim 11, wherein the processor is further configured to annex the CLI report onto one or more other measurement reports that are outlined by a 3rd Generation Partnership Project (3GPP) standard, and
wherein the transceiver is further configured to report the one or more other measurement reports on the PUCCH.

14. The electronic device of claim 13, wherein the one or more other measurement reports comprises a Hybrid Automatic Repeat Request (HARQ) report.

15. The electronic device of claim 13, wherein resources on the PUCCH identified in the CLI report configuration are resources on the PUCCH that are similarly identified by the DCI to report the HARQ report.

16. The electronic device of claim 13, wherein the processor is configured to measure a CLI-reference signal received power (CLI-RSRP), a CLI-received signal strength indicator (CLI-RSSI), a CLI-reference signal received quality (CLI-RSRQ), or a CLI-signal-to-interference-plus-noise ratio (CLI-SINR) of the CLI resource.

17. An electronic device, comprising:
a memory that stores a plurality of instructions; and
a processor configured to execute the plurality of instructions stored in the memory, the plurality of instructions, when executed by the processor, configuring the processor to:
recover a CLI report configuration from a downlink (DL) Media Access Control-Control Element (MAC-CE) on a Physical Downlink Shared Channel (PDSCH),
perform a CLI measurement of a CLI resource identified in the CLI report configuration over one or more CLI measurement occasions identified in the CLI report configuration to provide one or more CLI measurements, and
generate a CLI report of the one or more CLI measurements that is to be reported on a Physical Uplink Shared Channel (PUSCH) using an uplink (UL) MAC-CE to another electronic device within a wireless network.

18. The electronic device of claim 17, wherein the electronic device comprises a user equipment (UE), and
wherein the other electronic device comprises a base station (BS).

19. The electronic device of claim 17, wherein the plurality of instructions, when executed by the processor, further configure the processor to annex the CLI report onto one or more other measurement reports that are outlined by a 3rd Generation Partnership Project (3GPP) standard.

20. The electronic device of claim 17, wherein the one or more other measurement reports comprises a Hybrid Automatic Repeat Request (HARQ) report.
